(19) United States
(12) Patent Application Publication
(10) Pub. No.: US 2013/0044288 A1
(43) Pub. Date: Feb. 21, 2013

(54) EYEGLASSES STRUCTURE

(71) Applicant: YA-YUN CHENG, TAIPEI CITY (TW)

(72) Inventor: YA-YUN CHENG, TAIPEI CITY (TW)

(73) Assignee: EAKAU INTERNATIONAL OPTICAL-ELECTRONIC CO., LTD., YUNLIN COUNTY (TW)

(21) Appl. No.: 13/308,778

(22) Filed: Dec. 1, 2011

(30) Foreign Application Priority Data
Aug. 19, 2011 (TW) 100129725

(51) Int. Cl. G02C 5/22

(52) U.S. Cl. 351/121

(57) ABSTRACT

An eyeglass structure mainly has a frame. Two extension segments are provided respectively at both sides of the eyeglass frame and the extension segments combine with connectors for pivotal connection with eyeglass temples. Each extension segment has an elastic portion which is connected with one end of a link member. The other end of each link member is in hooking engagement with an eyeglass temple. When the temples are unfolded to open, the elastic portions are deformed by the press from the link members so as to fix the unfolding state of the eyeglass temples. The eyeglass temples can be folded with only slight push by the elastic recovery force of the elastic portions.

### BACKGROUND OF INVENTION

1. Field of the Invention

The present invention relates to an eyeglass structure, more particularly to an eyeglass structure in which the frame and the temples can be assembled without the usage of screws, and in which the temples can be folded and unfolded with slight push by the action of members directly formed on the eyeglass frame and members connected with each other.

2. Brief Description of the Prior Art

Eyeglasses are normally formed by assembling the temples to the frame and then setting the glasses in places. Both the frame and the temples are provided with hinge portions. The assembly of the frame and the temples is completed by combining both the hinge portions at both sides of the frame. Therefore, conventional eyeglasses have to conduct screw fastening on the hinge portions so as to assemble the frame and the temples together.

Current eyeglasses basically use screws for the connection between the frame and the temples and between the frame and the nose pads. However, screws are easily loosened or even fallen off after usage for a period of time. If not fastened at once, the screws are easily get detached and lost, and even the detachment of eyeglass members will be happened. Even if the missing screws are found, the fastening of the tiny screws is very inconvenient for users. Hence, this will cause troublesome in assembly process and to eyeglasses wearers.

In view of the above disadvantage, the inventor of the present invention provides a novel eyeglasses structure according to the research and improvement conducted on the conventional structure and based on his proficient experience in R&D and manufacturing in relevant field, so as to achieve better practical value.

### SUMMARY OF INVENTION

The main object of the present invention is to provide an eyeglass structure, more particularly to an eyeglass structure in which the frame and the temples can be assembled without the usage of screws, and in which the temples can be folded or unfolded only with slight push by the members directly formed on the eyeglass frame and other members connected with each other.

The object and effect of the eyeglass structure of the present invention is achieved by the following technology.

An eyeglass structure mainly has an eyeglass frame, two extension segments being provided respectively at both sides of the eyeglass frame, the extension segments combining with connectors for pivotal connection with eyeglass temples, each extension segment having an elastic portion which is connected with one end of a link member, the other end of each link member being in hooking engagement with an eyeglass temple. Configuring like this, when the temples are unfolded, the elastic portions are deformed by the press from the link members so as to fix the unfolding state of the eyeglass temples. The eyeglass temples can be folded with only slight push by the elastic recovery force of the elastic portions.

### BRIEF DESCRIPTION OF THE DRAWINGS

FIG. 1 is a schematic perspective exploded view showing the eyeglass structure of the present invention.

FIG. 2 is a schematic view showing assembly process of the present invention.

FIG. 3 is another schematic view showing assembly process of the present invention.

FIG. 4 is a schematic sectional view showing the lift-up state of the temples of the eyeglass structure of the present invention.

FIG. 5 is a schematic view showing the folded state of the present invention.

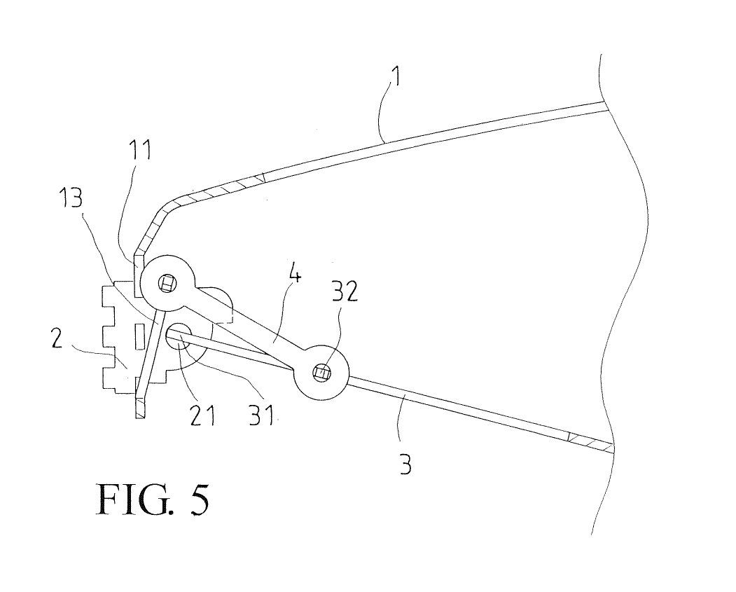

### DETAILED DESCRIPTION OF PREFERRED EMBODIMENTS

The objects, the technical contents and the expected effect of the present invention will become more apparent from the detailed description of the preferred embodiment in conjunction with the accompanying drawings.

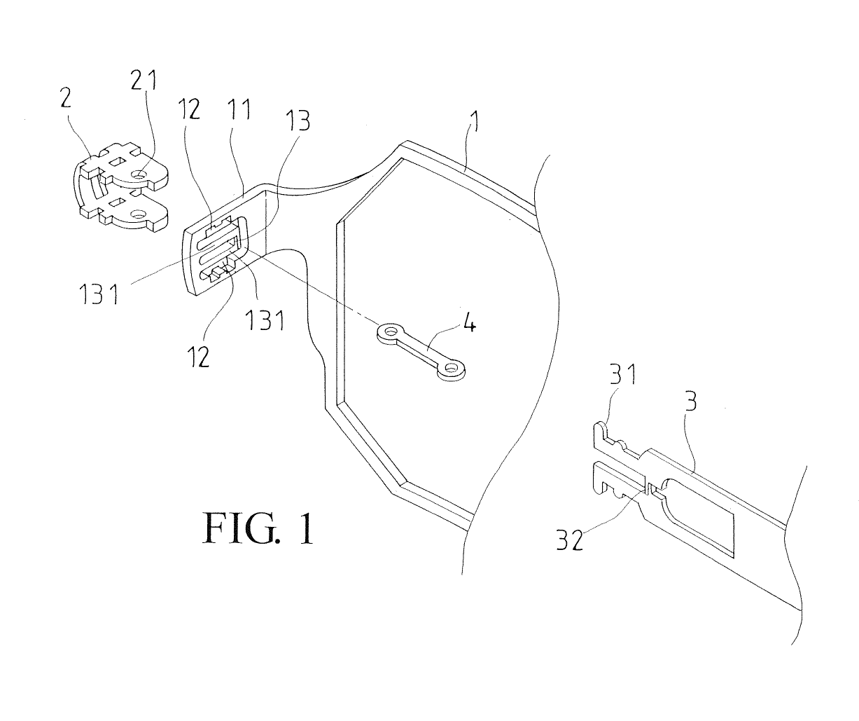

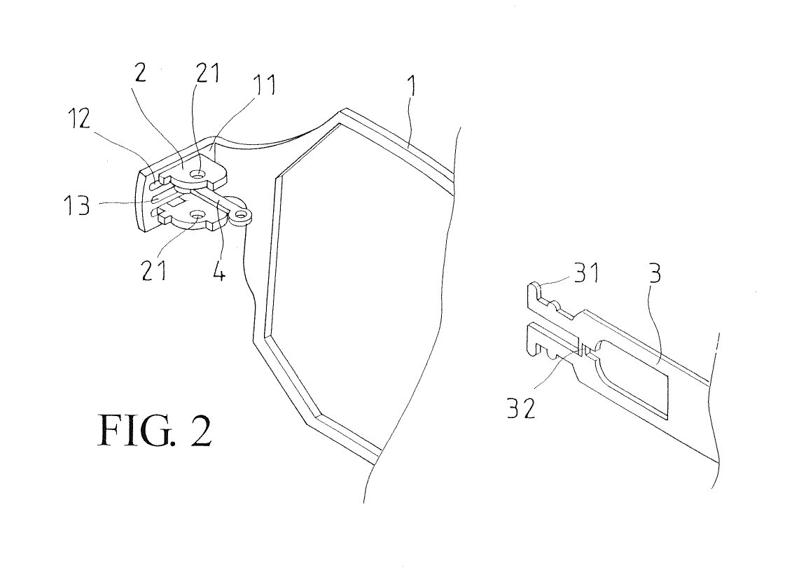

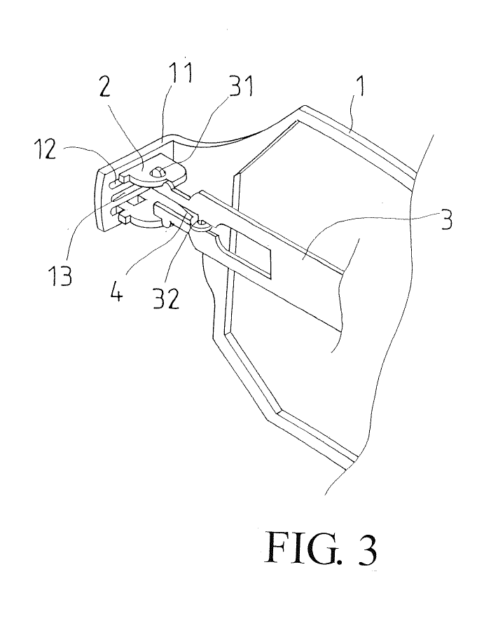

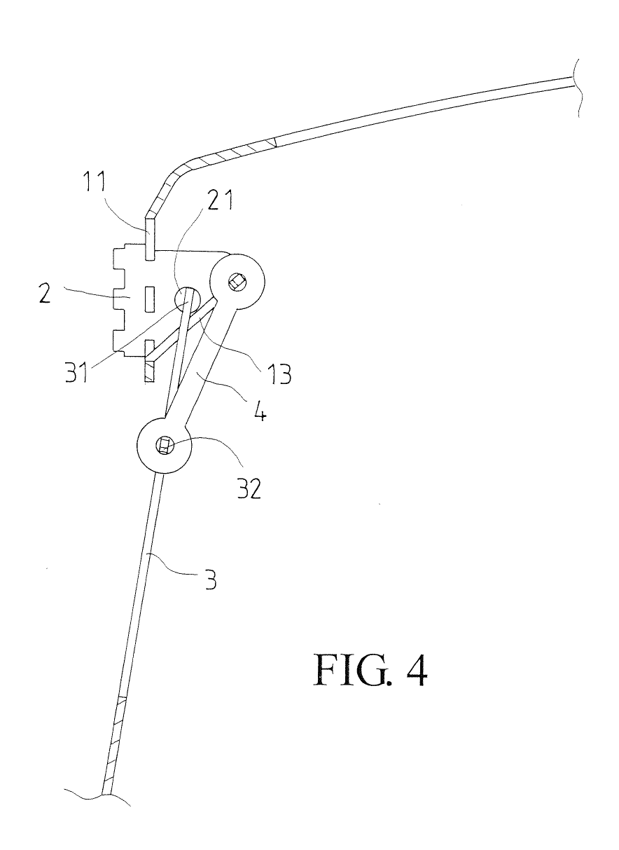

Referring to FIGS. 1 to 4, the eyeglass structure of the present invention comprises:
an eyeglass frame (1) having two extension segments (11) provided respectively at both sides thereof, elastic portions (13) being extended from the extension segments (11) toward slots (12), each elastic portion (13) being formed by dislocation frame of two support rods (131);
two connectors (2) inserted respectively through the slots (12) of the extension segments (11) on the frame (1), a pivot hole (21) being provided on each connector (2);
two temples (3) having pivot ends (31) for pivotally engaging with the pivot holes (21) of the connectors (2), the temples (3) having engaging portions (32) thereon;
two link member (4) having their first ends combined with the elastic portions (13) provided on the extension segments (11) of the eyeglass frame (1) by penetrating through the two dislocation support rods (131), while the second ends are in hooking engagement with the engaging portions (32) of the eyeglass temples (3).

Referring to FIGS. 1 to 4, when conducting assembly, the connectors (2) pass respectively through the slots (12) provided on the extension segments (11) at both sides of the eyeglass frame (1), then the link members (4) are inserted into the elastic portions (13) of the extension segments (11) and allow the first ends of the link members (4) perforating the two dislocation support rods (131) so as to be fixed on the elastic portions (13). In turn, the pivot ends (31) of the two temples (3) are pivotally engaged with the pivot holes (21) of the connectors (2) and the second ends of the link members (4) are in hooking engagement with the engaging portions (32) of the temples (3). The assembly is thus completed.

When the temples are unfolded for usage, the pivot ends (31) of the two temples (3) pivot to the outside with the pivot holes (21) of the connectors (2) as the centers. In the process of unfolding of the temples (3), the link members (4) in hooking engagement with the engaging portions (32) of the temples (3) will force the elastic portions (13) to be bent in such a manner that the elastic portions (13) maintain the unfolding status of the temples (3). On the other hand, when the temples are to be folded, slight forces are applied to the outsides of the temples (3) so as to rotate the temples (3) to the insides, then spring-back of the elastic portions (13) are triggered in such a manner that the link members (4) can force the temples (3) back to folding state.

The extension segments (11) of the eyeglass frame (1) and the slots (12) on the extension segments (11) can be formed by integral stamping process, and the pivot ends (31) of the temples (3) and the engaging portions (32) are also formed by integral stamping process. Hence, manufacturing process becomes very easy.

It is to be understood that the abovementioned embodiment and the drawings are not intended to limit the product structure and the using method of the present invention. Appropriate variations or modifications conducted by the person having general knowledge in the art are still regarded to be within the scope of the invention.

Based on foregoing, the eyeglass structure of the present invention has the advantages listed below when compared with prior art.

1. In the eyeglass structure of the present invention, the frame and the temples can be assembled by the members directly formed on the eyeglass frame and the other members connected therewith, without the usage of screws. Therefore, the assembly and usage are very convenient.

In the eyeglass structure of the present invention, when the temples are to be unfolded, the link members force the elastic portions to bend in such a manner that the elastic portions maintain the unfolding status of the temples. On the other hand, when the temples are to be folded, only slight forces are applied to the outsides of the temples so as to rotate the temples to the insides, then spring-back of the elastic portions is triggered in such a manner that the link members can force the temples back to folding state.

What is claimed is:

1. An eyeglass structure, comprising:
an eyeglass frame having two extension segments provided respectively at both sides thereof, slots being formed on said extension segments and elastic portions being extended from said extension segments toward said slots;
two connectors inserted respectively through said slots of said extension segments on said frame, a pivot hole being provided on each said connectors;
two temples having pivot ends for pivotally engaging with the pivot holes of said connectors, said temples having engaging portions thereon;
two link members having their first ends combined with said elastic portions provide on said extension segments of said eyeglass frame, while the second ends are in hooking engagement with said engaging portions of said eyeglass temples.

2. The eyeglass structure as claimed in claim 1, wherein each said elastic portion is formed by dislocation frame of two support rods, the first end of said link member being fixed on said elastic portion by perforating through said two dislocation support rods.

3. The eyeglass structure as claimed in claim 1, wherein said extension segments on said eyeglass frame, and said slots and said elastic portions of said extension segments are formed by integral stamping process.

4. The eyeglass structure as claimed in claim 1, wherein said pivot ends and said engaging portions of said temples are formed by integral stamping process.

5. The eyeglass structure as claimed in claim 3, wherein said pivot ends and said engaging portions of said temples are formed by integral stamping process.
